(19) United States
(12) Patent Application Publication
(10) Pub. No.: US 2024/0162435 A1
(43) Pub. Date: May 16, 2024

(54) METHOD FOR PRODUCING LAYERED COMPOSITE METAL OXIDE CRYSTAL MATERIAL

(71) Applicant: NATIONAL UNIVERSITY CORPORATION HOKKAIDO UNIVERSITY, Hokkaido (JP)

(72) Inventors: Masaki MATSUI, Hokkaido (JP); Rannosuke MAEDA, Hyogo (JP)

(73) Assignee: NATIONAL UNIVERSITY CORPORATION HOKKAIDO UNIVERSITY, Hokkaido (JP)

(21) Appl. No.: 18/282,351

(22) PCT Filed: Mar. 17, 2022
(86) PCT No.: PCT/JP2022/012276

§ 371 Date: Sep. 15, 2023

(30) Foreign Application Priority Data
Mar. 19, 2021 (JP) 2021-045633

(51) Int. Cl. H01M 4/525; C01G 51/00; C01G 53/00; H01M 4/02; H01M 4/1391; H01M 4/505; H01M 10/0525; H01M 10/0587

(52) U.S. Cl. CPC H01M 4/525; C01G 51/42; C01G 53/50; H01M 4/1391; H01M 4/505; H01M 10/0525; H01M 10/0587; C01P 2002/20; C01P 2002/50; C01P 2002/72; C01P 2006/40; H01M 2004/028

(57) ABSTRACT

The objective of the present invention is to provide a method for producing a layered composite metal oxide crystal material, which can be utilized as a positive electrode material for a lithium ion secondary battery or the like, in a milder condition, and methods for producing a positive electrode and a lithium ion secondary battery using the above method. The method for producing a layered composite metal oxide crystal material according to the present invention, wherein the layered composite metal oxide crystal material comprises a composite metal oxide represented by the formula: LiₓMO_{y} wherein M is 1 or 2 or more of transition metals, and a part of the M may be substituted with Al and/or Mg, x is the number of 1 or more and 2 or less, y is the number of 2 or more and 3 or less, a value of x+n is 2×y, wherein n is an average valence of the transition metal M, is characterized in comprising the step of calcining a mixture comprising a monovalent anion salt of lithium, a monovalent anion salt of sodium and/or potassium, and a monovalent anion salt of the transition metal at 150° C. or higher and 400° C. or lower in the presence of a water molecule and oxygen.

### TECHNICAL FIELD

The present invention relates to a method for producing a layered composite metal oxide crystal material in a milder condition. The layered composite metal oxide crystal material can be utilized as a positive electrode material for a lithium ion secondary battery, or the like.

### BACKGROUND ART

Renewable energies such as solar power and wind power become more widespread toward the realization of a sustainable low-carbon society. Since the amount of renewable energy depends on the weather, a stationary power storage system is also needed in order to ensure a stable supply of energy. In addition, an electric vehicle and a plug-in hybrid vehicle equipped with a storage battery are actively developed in the automobile field in order to reduce carbon dioxide emission.

A lithium ion secondary battery has been developed as a storage battery. A material having a host structure is used as an active substance for a positive electrode and a negative electrode for a lithium ion secondary battery. A lithium ion can be inserted into the host structure and emitted from the host structure. A lithium ion secondary battery can be charged and discharged by giving and receiving a lithium ion between the electrodes. A layered crystal of lithium cobaltite (LiCoO₂) is mainly used as a positive electrode material of a lithium ion secondary battery, since the various properties of the layered crystal are suitable for a battery. For example, a layered crystal of lithium cobaltite can be relatively easily synthesized, is easy to deal with, and has high operating voltage and long cycle life. A layered crystal of lithium cobaltite has a crystal structure constructed by alternating a COO₂ layer and a lithium ion. The lithium ion is removed from the CoO₂ layers or received between the CoO₂ layers.

A layered crystal of lithium cobaltite is generally produced by a solid phase method that has a high temperature calcining process at 700 to 900° C., and it is known that a low active spinel crystal is produced by calcining at relatively low temperature at 300 to 600° C. (Non-patent document 1). On the one hand, a method for producing a lithium cobaltite crystal by a flux method is suggested as a production method with lower energy consumption (Non-patent document 2), since large scale synthesis with high temperature calcining process requires a lot of energy. However, calcining at 500° C. is required even in this method.

Patent document 1 discloses a method for producing a layered alkali metal oxide material having a single layer at relatively low temperature such as about 50 to 150° C. by a hydrothermal synthesis method using an oxyhydroxide of a transition metal as a raw material. However, the method is not suitable for a large scale synthesis, since a long term reaction under high pressure, such as under about 6.5 atm for about 5 days and under about 30 to 35 atm for 2 days, is needed for the method. In addition, the method requires a closed container with high pressure resistance.

### PRIOR ART DOCUMENT

### Patent Document

Patent document 1: JP H10-510239 T

### Non-Patent Document

Non-patent document 1: ARIYOSHI Kingo et al., J. Phys. Chem. C, 2020, 124, 8170-8177
Non-patent document 2: T. YODA et al., RSC Adv., 2015, 5, 96002-96007

### DISCLOSURE OF THE INVENTION

### Problems to be Solved by the Invention

A layered composite metal oxide crystal material useful as a positive electrode material for a lithium ion secondary battery or the like is produced through a high temperature calcining process or a hydrothermal synthesis under high pressure for a long time as described above. It is, however, needed to develop a low cost synthesis process at a lower temperature under an atmospheric pressure for large scale synthesis.

Thus, the objective of the present invention is to provide a method for producing a layered composite metal oxide crystal material, which can be utilized as a positive electrode material for a lithium ion secondary battery or the like, in a milder condition, and methods for producing a positive electrode and a lithium ion secondary battery using the above method.

### Means for Solving the Problems

The inventors of the present invention repeated intensive studies in order to solve the above-described problems. As a result, the inventors completed the present invention by finding that a layered composite metal oxide crystal material comprising lithium and a transition metal can be produced at relatively low temperature under an atmospheric pressure by using the specific raw material compounds.

The present invention is hereinafter described.
[1] A method for producing a layered composite metal oxide crystal material,
   wherein the layered composite metal oxide crystal material comprises a composite metal oxide represented by the following formula:

LiₓMO_{y}

wherein
M is 1 or 2 or more of transition metals, and a part of the M may be substituted with Al and/or Mg,
x is the number of 1 or more and 2 or less,
y is the number of 2 or more and 3 or less,
a value of x+n is 2×y, wherein n is an average valence of the transition metal M,
   comprising the step of calcining a mixture comprising a monovalent anion salt of lithium, a monovalent anion salt of sodium and/or potassium, and a monovalent anion salt of the transition metal at 150° C. or higher and 400° C. or lower in the presence of a water molecule and oxygen.
[2] The method according to the above [1], wherein a hydrate is used as 1 or more of the salts selected from the group consisting of the monovalent anion salt of lithium, the monovalent anion salt of sodium and/or potassium, and the monovalent anion salt of the transition metal.
[3] The method according to the above [1], wherein the mixture comprises water.
[4] The method according to any one of the above [1] to [3], wherein a molar ratio of the monovalent anion salt of sodium and/or potassium to the monovalent anion salt of lithium is 0.1 or more and 5 or less.
[5] The method according to any one of the above [1] to [4], wherein the mixture is calcined at an atmospheric pressure.
[6] The method according to any one of the above [1] to [5], wherein the mixture further comprises a monovalent anion salt of aluminum and/or magnesium in the case where a part of the M is substituted with Al and/or Mg.
[7] A method for producing a positive electrode, comprising the steps of:
   producing a layered composite metal oxide crystal material according to any one of the above [1] to [6],
   mixing the layered composite metal oxide crystal material with at least a solvent and a binder to produce a positive electrode slurry,
   coating a positive electrode current collector with the positive electrode slurry, and
   drying the positive electrode slurry on the positive electrode current collector.
[8] A method for producing a lithium ion secondary battery, comprising the steps of:
   producing a positive electrode on the positive electrode current collector according to the above [7],
   producing a negative electrode on a negative electrode current collector,
   producing a winding body by winding the positive electrode current collector having the positive electrode, the negative electrode current collector having the negative electrode, and a separator between the positive electrode current collector and the negative electrode current collector, and
   placing the winding body in a battery container and injecting an electrolyte liquid into the battery container.

### Effect of the Invention

A layered composite metal oxide crystal material comprising lithium and a transition metal can be easily produced at relatively low temperature without high pressure by using the specific raw material compounds according to the present invention. Thus, the present invention is industrially very useful, since a layered composite metal oxide crystal material, which is useful as a positive electrode material for a lithium ion secondary battery or the like, can be synthesized on a large scale at low cost.

### BRIEF DESCRIPTION OF THE DRAWINGS

FIG. 1 is a figure to show the results of X-ray diffraction analysis of the LiCoO₂ powders of Examples according to the present invention and Comparative Examples.

FIG. 2 is a figure to show the results of charge-discharge test of half cells having the electrodes prepared from the LiCoO₂ powders in Examples of the present invention and Comparative examples.

FIG. 3 is a figure to show the analysis result of LiNi_{1/3}Mn_{1/3}Co_{1/3}O, powder of Example of the present invention by X-ray diffraction method.

FIG. 4 is a figure to show the analysis results of LiCoO₂ powders of Examples of the present invention by X-ray diffraction method.

FIG. 5 is a figure to show the results of charge-discharge test of half cells having the electrode prepared from the LiCoO₂ powders in Examples of the present invention.

FIG. 6 is a figure to show the analysis results of LiCoO₂ powders of Examples of the present invention by X-ray diffraction method.

### MODE FOR CARRYING OUT THE INVENTION

The method for producing a layered composite metal oxide crystal material according to the present invention comprises the step of calcining a mixture comprising a monovalent anion salt of lithium, a monovalent anion salt of sodium and/or potassium, and a monovalent anion salt of a transition metal at 150° C. or higher and 400° C. or lower in the presence of a water molecule and oxygen.

The layered composite metal oxide crystal material according to the present invention is a composite oxide of lithium and a transition metal, and the monovalent anion salt of lithium is an important raw material comprising lithium for the target compound.

A counter anion of the monovalent anion salt of lithium, the monovalent anion salt of sodium and/or potassium, and the monovalent anion salt of the transition metal is not particularly restricted as long as the counter anion is a monovalent anion and can form salts with a lithium ion, a sodium ion and/or a potassium ion, and a transition metal ion. An example of the counter anion includes hydroxide ion (OH⁻), nitrate ion (NO₃⁻), halide ion, cyanide ion (CN⁻), acetate ion (CH₃CO₂⁻) and hydrogen carbonate ion (HCO₃⁻). An example of halide ion includes fluoride ion, chloride ion, bromide ion and iodide ion. The halide ion is preferably chloride ion, bromide ion and iodide ion. The anion is preferably hydroxide ion, nitrate ion and halide ion, more preferably hydroxide ion and nitrate ion, and even more preferably hydroxide ion. When a monovalent anion salt of aluminum and/or magnesium is further used, an example of an anion of the salt includes the above-described anions.

The monovalent anion salt of sodium and/or potassium has an effect to wholly reduce the melting point with the monovalent anion salt of lithium and may accelerate the reaction of the monovalent anion salt of lithium and/or the monovalent anion salt with the transition metal under relatively low temperature by forming a molten salt with the monovalent anion salt of lithium. For example, the phase diagram of lithium hydroxide-sodium hydroxide shows the lowest eutectic point in the case of lithium hydroxide:sodium hydroxide=3:7 by molar ratio, and the eutectic point is 493K (220° C.) (A. Kacprzak et al., Journal of Power Sources, 239 (2013), 409-414). On the one hand, it was a surprising result that a layered composite metal oxide crystal material could be successfully produced by calcining at low temperature as 300° C. even in the case of the composition that significantly deviates from the composition at the eutectic point, such as the composition of lithium hydroxide:sodium hydroxide=3:1 by molar ratio (Example 1) by the present inventor's experimental finding.

The usage amount of the monovalent anion salt of sodium and/or potassium may be appropriately adjusted as long as the reaction of the present invention proceeds. For example, 0.1 times or more by mole and 5 times or less by mole of the monovalent anion salt can be used to 1 mole of the monovalent anion salt of lithium. When the molar ratio is 0.1 times or more by mole, the monovalent anion salt of sodium and/or potassium may accelerate the reaction more surely. On the one hand, when the molar ratio is 5 times or less by mole, the monovalent anion salt of sodium and/or potassium may be prevented from remaining in the layered composite metal oxide crystal material as the target compound. The molar ratio is preferably 0.2 times or more by mole, more preferably 0.25 times or more by mole, even more preferably 0.3 times or more by mole, and preferably 2.5 times or less by mole, more preferably 1 time or less by mole, even more preferably 0.5 times or less by mole. One of the monovalent anion salt of sodium and the monovalent anion salt of potassium may be used alone, or the monovalent anion salts may be used in combination.

The layered composite metal oxide crystal material produced by the present invention is a composite oxide of lithium and the transition metal, and the monovalent anion salt of the transition metal is an important raw material comprising the transition metal that constitutes the target compound.

The transition metal is not particularly restricted, one or more first-row transition metals selected from scandium, titanium, vanadium, chromium, manganese, iron, cobalt, nickel, copper and zinc can be used, one or more first-row transition metals selected from manganese, cobalt and nickel are preferred, and at least cobalt and/or nickel is preferably used. The monovalent anion salt of magnesium and/or aluminum may be additionally used in combination.

Only one kind of the transition metal may be used, and two or more kinds of the transition metals may be used in combination. When two or more kinds of the transition metals are used in combination, the upper limit of the number of the transition metals is not particularly restricted and the number may be 5 or less. The number is preferably 4 or less, and more preferably 1 or 2 or 3. A part of the transition metal in the layered composite metal oxide crystal material produced by the present invention may be substituted with Al and/or Mg, especially with Al. When a part of the transition metal is substituted with Al and/or Mg, a ratio of Al and Mg to total 100 mol % of the transition metal and Al and Mg may be adjusted to 1 mol % or more and 10 mol % or less. The ratio is preferably 2 mol % or more, more preferably 3 mol % or more, and preferably 8 mol % or less, more preferably 6 mol % or less. For example, the ratio may be adjusted to 3.5±0.5 mbl % and 5.0±0.5 mol %.

The usage amount of the monovalent anion salt of the transition metal may be appropriately adjusted as long as the reaction of the present invention proceeds, and for example, 0.1 times or more by mole and 1 time or less by mole of the monovalent anion salt may be used to 1 mole of the monovalent anion salt of lithium. When the ratio is 0.1 times or more by mole, a sufficient amount of the layered composite metal oxide crystal material may be produced without trouble more surely. On the one hand, when the ratio is 1 time or less by mole, the layered composite metal oxide crystal material can be theoretically synthesized. The ratio is preferably 0.2 times or more by mole, more preferably 0.5 times or more by mole, and preferably 0.9 times or less by mole, more preferably 0.8 times or less by mole, even more preferably 0.7 times or less by mole. Only one kind of the monovalent anion salt of the transition metal may be used alone, or two or kinds of the monovalent anion salts may be used in combination. When the layered composite metal oxide crystal material in which a part of the transition metal is substituted with Al and/or Mg is produced, the usage amount of the monovalent anion salt of Al and/or Mg may be determined depending on the desired ratio of Al and Mg to the total 100 mol % of the transition metal and Al and Mg.

The mixture comprising the monovalent anion salt of lithium, the monovalent anion salt of sodium and/or potassium, and the monovalent anion salt of the transition metal is calcined in the presence of a water molecule according to the present invention method. The role of a water molecule in the reaction of the present invention is not necessarily clear, but a water molecule may release a proton as a bronsted acid in the molten salt formed by calcining the monovalent anion salt of sodium and/or potassium to accelerate the melting and the recrystallization of the transition metal in the molten salt. As a result, the water molecule may play an important role to accelerate the reaction at relatively low temperature and the growth of the product crystal. Thus, a water molecule may play an important role for accelerating the reaction at relatively low temperature and the growth of the product crystal.

The phrase “in the presence of a water molecule” is not particularly restricted as long as a water molecule exists in the reaction system of the present invention. For example, a hydrate may be used as 1 or more of the raw material compounds selected from the monovalent anion salt of lithium, the monovalent anion salt of sodium and/or potassium, and the monovalent anion salt of the transition metal. A stable compound such as monohydrate and dihydrate may be used as the hydrate. For example, a hydrate of the monovalent anion salt of lithium is preferably used. When the monovalent anion salt of lithium is used, a dehydration reaction may proceed by calcining to leave a monovalent anion and thus the product with higher purity may be produced.

Alternatively, water is added to the mixture comprising the monovalent anion salt of lithium, the monovalent anion salt of sodium and/or potassium, and the monovalent anion salt of the transition metal, and the mixture is kneaded to obtain a slurry. For example, 1 time or more by mole and 5 times or less by mole of water to the total mole of the monovalent anion salt of lithium, the monovalent anion salt of sodium and/or potassium, and the monovalent anion salt of the transition metal may be used. The ratio is preferably 4 times or less by mole and more preferably 2 times or less by mole. In addition, a hydrate is used as the 1 or more of the raw material compounds of the monovalent anion salt of lithium, the monovalent anion salt of sodium and/or potassium, and the monovalent anion salt of the transition metal, and water is added to produce a slurry from the mixture. The total mole number of the water molecule in the hydrate and the separately added water molecule is preferably adjusted in the above-described range.

The slurry may be formed into a desired shape. Even when a hydrate is used as the raw material compound without adding water, the mixture may be formed into a desired shape under pressure to successfully accelerate the solid phase reaction by increasing the contact area between the raw material compounds. The solid phase reaction may successfully proceed without forming a shape in the case of the slurry, since the contact area between the raw material compounds is large.

The above-described mixture is calcined in the presence of oxygen in the present invention. For example, the mixture may be calcined in the air. When oxygen is insufficient in the case of the calcining in the air, oxygen may be supplied to the mixture. The oxygen partial pressure in the calcining process of the present invention is not needed to be high, and the mixture may be calcined under an approximate oxygen partial pressure of atmospheric pressure.

The layered composite metal oxide crystal material can be successfully produced by calcining at relatively low temperature, specifically 150° C. or higher and 400° C. or lower, according to the present invention. The temperature is preferably 350° C. or lower, more preferably 300° C. or lower, and even more preferably 280° C. or lower or 250° C. or lower, in terms of the production cost. The temperature is preferably 180° C. or higher or 200° C. or higher and more preferably 220° C. or higher with respect to the lower limit of the calcining temperature in terms of the formation of the molten salt. When the monovalent anion salt of sodium and the monovalent anion salt of potassium are used in combination, the calcining temperature can be further reduced.

The calcining time may be appropriately adjusted as long as the calcining is sufficiently carried out to successfully produce the layered composite metal oxide crystal material as the target compound, and for example, may be adjusted to 10 minutes or more and 50 hours or less. The calcining time is preferably 20 minutes or more, more preferably 25 minutes or more, and preferably 40 hours or less, more preferably 30 hours or less, even more preferably 20 hours or less or 15 hours or less.

A general aftertreatment is preferably carried out after the calcining. For example, the calcined mixture is pulverized and then washed using a highly polar solvent to remove the remaining raw material compound such as the monovalent anion salt of lithium and the monovalent anion salt of sodium and/or potassium. An example of the solvent for washing includes water; an alcohol solvent such as methanol, ethanol and 2-propanol; a nitrile solvent such as acetonitrile, propionitrile and valeronitrile; an ether solvent such as diethyl ether and tetrahydrofuran; and a mixed solvent thereof. The product and the solvent may be separated by filtration, centrifugation or the like after the washing. The slightly remaining solvent may be removed by heating or reduced pressure.

The layered composite metal oxide crystal material produced by the present invention method comprises the composite metal oxide represented by the following formula:

LiₓMO_{y}

wherein M is 1 or 2 or more of transition metals, and a part of the M may be substituted with Al and/or Mg; x is the number of 1 or more and 2 or less; y is the number of 2 or more and 3 or less; a value of x+n is 2×y, wherein n is an average valence of the transition metal M.

When the M is 2 or more transition metals as described above, the upper limit of the number of the transition metal is not particularly restricted and may be adjusted to, for example, 5 or less. The number is preferably 4 or less and more preferably 1 or 2 or 3. The number of the transition metal is preferably 1 or 2. A part of the M may be substituted with Al and/or Mg and may be particularly substituted with Al. When a part of the M is substituted with Al and/or Mg, a ratio of Al and Mg to the total 100 mol % of the transition metal and Al and Mg may be adjusted to 1 mol % or more and 10 mol % or less. The ratio is preferably 2 mol % or more, more preferably 3 mol % or more, and preferably 8 mol % or less, more preferably 6 mol % or less. For example, the ratio may be adjusted to 3.5±0.5 mol % and 5.0±0.5 mol %.

Though the reaction mechanism of the present invention is not necessarily clear, M(OH)₂ or M(OH)₃ may be first produced and then a part of the M may be substituted with lithium ion. Accordingly, 1 time or more by mole of the monovalent anion salt of lithium is preferably used to 1 mole of the monovalent anion salt of the transition metal. The ratio is preferably 1.2 times or more by mole and more preferably 1.4 times or more by mole. The layered composite metal oxide crystal material produced by the present invention method may be a lithium-rich material produced by the solid solution of LiMO₂ in Li₂MO₃.

An example of the chemical formula of the layered composite metal oxide crystal material produced by the present invention includes LiCoO₂, LiNiO₂, LiMnO₂, Li(Ni_{1/3}Mn_{1/3}Co_{1/3})O₂, LiNiₚMn_{q}CoᵣO₂ wherein p+q+r=1, for example, p=q=r=⅓; p=0.8, q=0.1, r=0.1; p=0.6, q=0.2, r=0.2; p=0.5, q=0.2, r=0.3, and LiNiₚCo_{q}AlᵣO₂ wherein p+q+r=1, for example, p=0.815, q=0.15, r=0.035.

For example, a lithium ion is released from the layered composite metal oxide crystal material of a positive electrode and C₆Li is produced at a carbon negative electrode in case of charge, and a lithium ion released from a negative electrode is inserted into a positive electrode in case of discharge in a lithium ion secondary battery.

For example, the layered composite metal oxide crystal material produced by the present invention method can be utilized as a positive electrode active substance of a positive electrode for a lithium ion secondary battery. The layered composite metal oxide crystal material is mixed with at least a solvent and a binder to obtain a positive electrode slurry, a positive electrode current collector is coated with the positive electrode slurry and the positive electrode slurry is dried to produce a positive electrode.

An example of the binder used for a positive electrode slurry includes polyvinylidene fluoride and a copolymer thereof, carboxymethylcellulose, styrene-butadiene rubber, polyimide, polytetrafluoroethylene, and a mixture thereof. An example of the solvent for a positive electrode slurry includes water; a nitrogen-containing organic solvent such as N-methylpyrrolidone, dimethylformamide and dimethylacetamide; a ketone solvent such as acetone, methyl ethyl ketone, cyclohexanone and methyl isobutyl ketone; an ester solvent such as ethyl acetate and butyl acetate; an ether solvent such as tetrahydrofuran and dioxane; and a mixed solvent thereof.

A general additive may be mixed in the positive electrode slurry in addition to the layered composite metal oxide crystal material and a binder. An example of such an additive for the positive electrode slurry includes an electrical conducting material. An example of an electrical conducting material includes a carbon material such as acetylene black, ketjen black, graphite and carbon nanofiber.

An example of a positive electrode current collector that is coated with the positive electrode slurry generally includes an aluminum foil, an etched aluminum foil, and an aluminum foil coated with a conductive paste.

The above-described positive electrode can be further used for producing a lithium ion secondary battery. Specifically, a lithium ion secondary battery can be produced by producing the negative electrode on the negative electrode current collector; winding a positive electrode current collector having a positive electrode, the negative electrode current collector having the negative electrode, and a separator between the positive electrode current collector and the negative electrode current collector to obtain a winding body; inserting the winding body in a battery container; and injecting an electrolyte liquid in the battery container.

The negative electrode can be produced by preparing a negative electrode slurry similarly to a positive electrode slurry except that a negative electrode active substance is used in place of the layered composite metal oxide crystal material as a positive electrode active substance, coating a negative electrode current collector with the negative electrode slurry, and drying the negative electrode slurry. An example of the negative electrode active substance includes a basic material comprising Si and/or Sn, such as Si, SiCuAl, SiNiAg and CoSn₂, in addition to a carbon material such as graphite. A cupper foil can be used as a negative electrode current collector.

A microporous polyolefin membrane is generally used as a separator of a lithium ion secondary battery. The winding body is produced by cutting a positive electrode and a negative electrode into the size that fits inside a battery container and by laminating and winding the positive electrode, the negative electrode and a separator between the positive electrode and the negative electrode. Then, the winding body is inserted in a battery container, and each electrode is welded to a cap or the like of the battery container. When a separator is used, a lithium ion secondary battery can be produced by injecting an electrolyte liquid in the battery container and welding the cap. An electrolyte liquid may be also injected from an inlet provided on the cap after the cap is welded.

The present application claims the benefit of the priority date of Japanese patent application No. 2021-45633 filed on Mar. 19, 2021. All of the contents of the Japanese patent application No. 2021-45633 filed on Mar. 19, 2021, are incorporated by reference herein.

### EXAMPLES

Hereinafter, the examples are described to demonstrate the present invention more specifically, but the present invention is in no way restricted by the examples, and the examples can be appropriately modified to be carried out within a range that adapts to the contents of this specification. Such a modified example is also included in the range of the present invention.

### Example 1

Lithium hydroxide monohydrate manufactured by FUJIFILM Wako Pure Chemical, sodium hydroxide manufactured by FUJIFILM Wako Pure Chemical and cobalt hydroxide manufactured by Kojundo Chemical Laboratory were mixed in a molar ratio of LiOH·H₂O:NaOH:Co(OH)₂=1.5:0.5:1.0 using a mortar to obtain a raw material, and the raw material was formed into a cuboid pellet of 5 mm×30 mm×5 mm under the pressure of 10 MPa using Cemented Carbide Dies manufactured by Sansho Industry. The pressure of 10 MPa was applied for the pelletization, but such pelletization is not necessarily needed. The productivity was not decreased due to the load of pressure, since the pressure was applied for a short time only.

The thus obtained pellet was calcined under an oxygen flow of 100 mL/min in a tubular furnace (“ARF-40KC” manufactured by Asahi Rika) at 300° C. for 12 hours. The calcined pellet was pulverized, washed with anhydrous ethanol to remove LiOH and NaOH, and then dried at 25° C. for 15 minutes to obtain LiCoO₂ powder.

### Example 2

LiCoO₂ powder was obtained similarly to Example 1 except that the molar ratio of the raw material was changed to LiOH. H₂O:NaOH:Co(OH)₂=1.5:1.5:1.0.

### Example 3

LiCoO₂ powder was obtained similarly to Example 1 except that the molar ratio of the raw material was changed to LiOH H₂O:NaOH:Co(OH)₂=1.5:3.5:1.0.

### Comparative Example 1

LiCoO₂ powder was obtained similarly to Example 1 except that sodium hydroxide was not used.

### Comparative Example 2

LiCoO₂ powder was obtained similarly to Example 3 except that anhydrous lithium hydroxide was used in place of lithium hydroxide monohydrate as the raw material.

### Test Example 1: X-Ray Diffraction

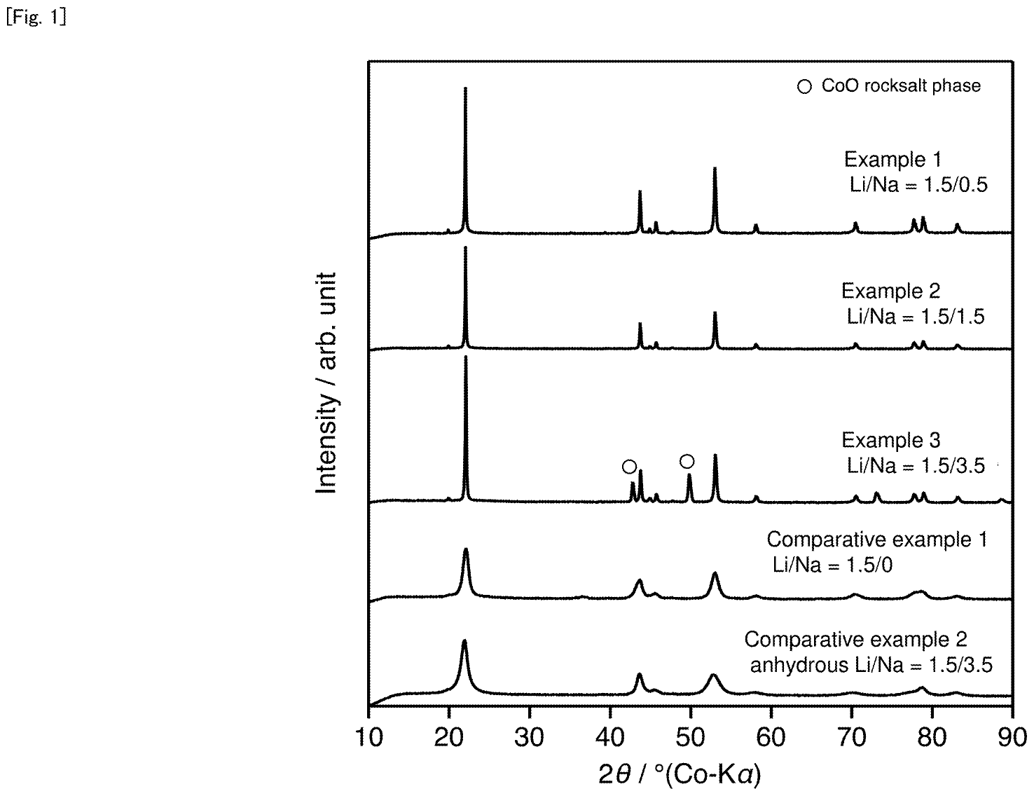

The LiCoO₂ powders produced by Examples 1 to 3 and Comparative examples 1 and 2 were analyzed by X-ray diffraction method. The result is shown in FIG. 1.

When sodium hydroxide was not used (Comparative example 1), the crystallinity was remarkably insufficient. It is presumed that Co₃O₄ and spinel type Li₂Co₂O₄ were produced as by-products in addition to layered LiCoO₂. When calcining was carried out in the absence of a water molecule (Comparative example 2), the crystallinity was also insufficient similarly to Comparative example 1 and the crystal of layered LiCoO₂ was not sufficiently grown.

On the one hand, the crystallinity of LiCoO₂ powders of Examples 1 to 3 was clearly confirmed. When the ratio of Li/Na of the used raw material was 1.5/3.5 (Example 3), rock salt type CoO was confirmed as a by-product.

### Test Example 2: Charge-Discharge Test

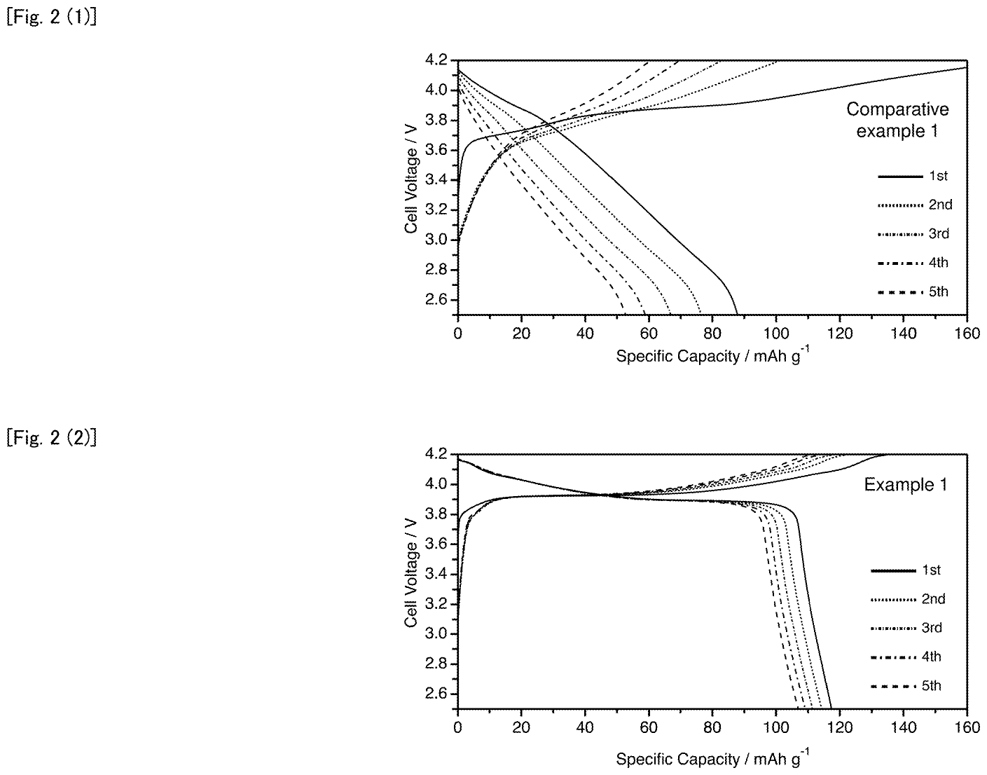

The synthesized LiCoO₂ powder, acetylene black manufactured by Denka as a conductive material, and polyvinylidene fluoride manufactured by Kureha as a binder were mixed with the mass ratio of 85:10:5, and a coated electrode was prepared. A half cell was prepared using the electrode and lithium metal as an opposite pole to carry out charge-discharge test. The result of the LiCoO₂ powder of Example 1 is shown in FIG. 2(2), and the result of the LiCoO₂ powder of Comparative example 1 is shown in FIG. 2(1).

The charging-discharging capacity was remarkably decreased by the repetition of charging and discharging in case of the electrode prepared from the LiCoO₂ powder of Comparative example 1 as the result shown in FIG. 2. The reason for the result may be that a certain phase other than the layered crystal was produced, though such a phase was not confirmed by X-ray diffraction analysis.

On the one hand, the charging-discharging capacity was about 120 mAhg⁻¹ and hardly decreased even when charging and discharging were repeated 5 times in case of the electrode prepared from the LiCoO₂ powder of Example 1.

### Example 4

LiNi_{1/3}MnCo_{1/3}O₂ powder was obtained similarly to Example 1 except that Ni_{1/3}Mn_{1/3}Co_{1/3}(OH)₂ was used in place of Co(OH)₂ as transition metal hydroxide.

### Example 5

Anhydrous lithium hydroxide, sodium hydroxide, cobalt hydroxide and water were mixed in a molar ratio of LiOH·H₂O:NaOH:Co(OH)₂:H₂O=1.5:0.5:1.0:4.5 to prepare a slurry.

LiCoO₂ powder was obtained similarly to Example 1 except that the prepared slurry was used.

### Example 6

LiCoO₂ powder was obtained similarly to Example 5 except that lithium hydroxide monohydride was used in place of anhydrous lithium hydroxide and the molar ratio of the raw material was changed to LiOH·H₂O:NaOH:Co(OH)₂:H₂O=1.5:0.5:1.0:3.0.

### Test Example 3: X-Ray Diffraction

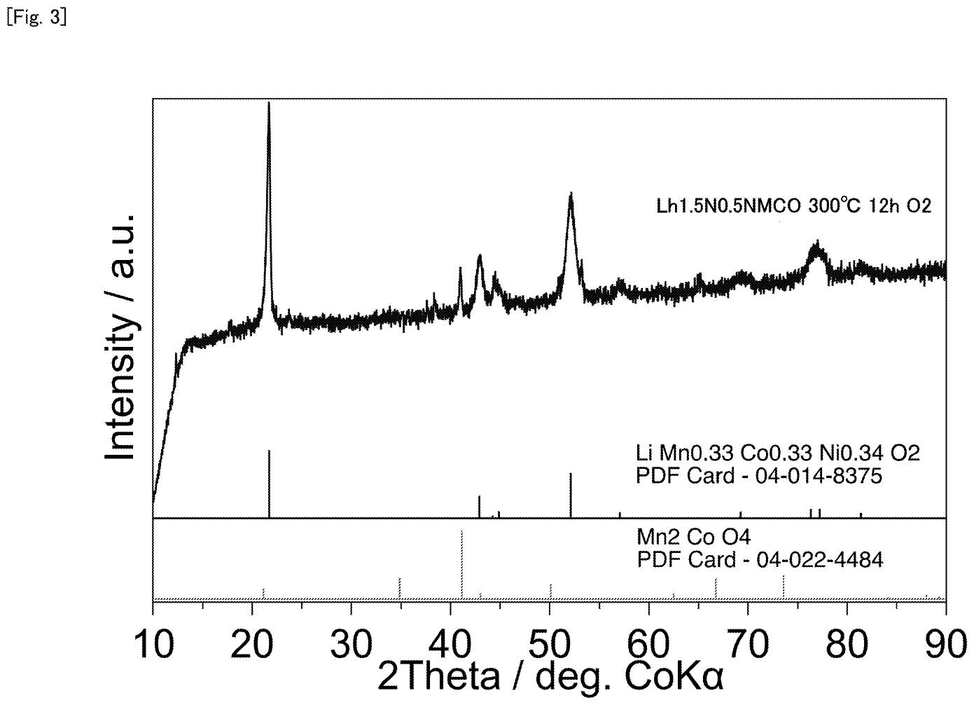

The LiNi_{1/3}Mn_{1/3}Co₃O₂ powder produced in Example 4 was analyzed by X-ray diffraction. The result is shown in FIG. 3 with the X-ray diffraction pattern data of LiNi_{0.33}Mn_{0.33}Co_{0.34}O₂ and Mn₂CoO₄ as Powder Diffraction File (PDF) 04-014-8375 and 04-022-4484.

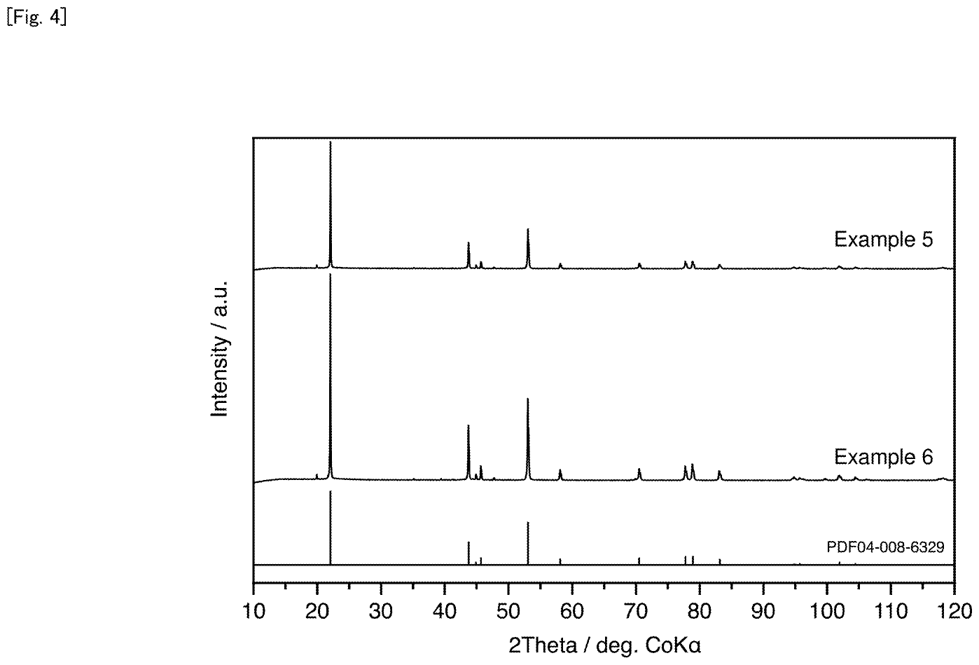

The LiCoO₂ powders produced in Example 5 and Example 6 were analyzed by X-ray diffraction. The result is shown in FIG. 4 with the X-ray diffraction pattern data of LiCoO₂ as PDF 04-008-6329.

The clear crystallinity of the LiNi_{1/3}Mn_{1/3}Co_{1/3}O₂ powder of Example 4 and the LiCoO₂ powders of Example 5 and Example 6 were confirmed as the results shown in FIG. 3 and FIG. 4.

### Test Example 4: Charge-Discharge Test

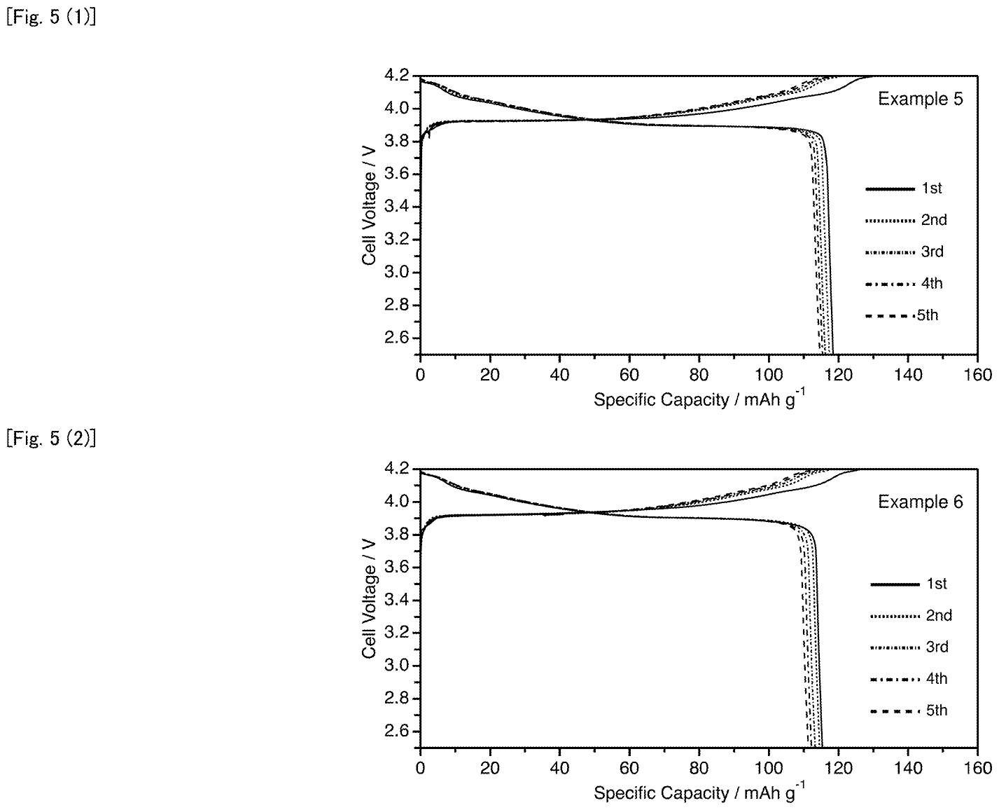

Electrodes were prepared from the LiCoO₂ powders produced in Example 5 and Example 6 and used for the charge-discharge test similarly to Test example 2. The result of the LiCoO₂ powder of Example 5 is shown in FIG. 5(1), and the result of the LiCoO₂ powder of Example 6 is shown in FIG. 5(2).

The charging-discharging capacity was 110 to 120 mAhg⁻¹ and hardly decreased even when charging and discharging were repeated 5 times in the case where the LiCoO₂ powder was produced from the raw material slurry containing water and the electrode was prepared from the LiCoO₂ powder.

### Example 7

Lithium hydroxide monohydrate manufactured by FUJIFILM Wako Pure Chemical, sodium hydroxide manufactured by FUJIFILM Wako Pure Chemical, potassium hydroxide manufactured by FUJIFILM Wako Pure Chemical and cobalt hydroxide manufactured by Kojundo Chemical Laboratory were mixed in the molar ratio of LiOHH₂O:NaOH:KOH:Co(OH)₂=1.5:0.25:0.25:1.0 using a mortar to prepare a raw material. The LiCoO₂ powder was produced similarly to Example 1 except that the raw material was used and the calcining temperature was changed from 300° C. to 250° C.

### Example 8

Lithium hydroxide monohydrate manufactured by FUJIFILM Wako Pure Chemical, sodium hydroxide manufactured by FUJIFILM Wako Pure Chemical, potassium hydroxide manufactured by FUJIFILM Wako Pure Chemical and cobalt hydroxide manufactured by Kojundo Chemical Laboratory were mixed in the molar ratio of LiOH·H₂O NaOH:KOH:Co(OH)₂=1.5:0.25:0.25:1.0 using a mortar to prepare a raw material. The LiCoO₂ powder was produced similarly to Example 1 except that the raw material was used and the calcining temperature was changed from 300° C. to 200° C.

### Example 9

Lithium hydroxide monohydrate manufactured by FUJIFILM Wako Pure Chemical, sodium hydroxide manufactured by FUJIFILM Wako Pure Chemical, potassium hydroxide manufactured by FUJIFILM Wako Pure Chemical and cobalt hydroxide manufactured by Kojundo Chemical Laboratory were mixed in the molar ratio of LiOH·H₂O:NaOH:KOH:Co(OH)₂=1.5:0.45:0.05:1.0 using a mortar to prepare a raw material. The LiCoO₂ powder was produced similarly to Example 1 except that the raw material was used and the calcining temperature was changed from 300° C. to 200° C.

### Test Example 5: X-Ray Diffraction

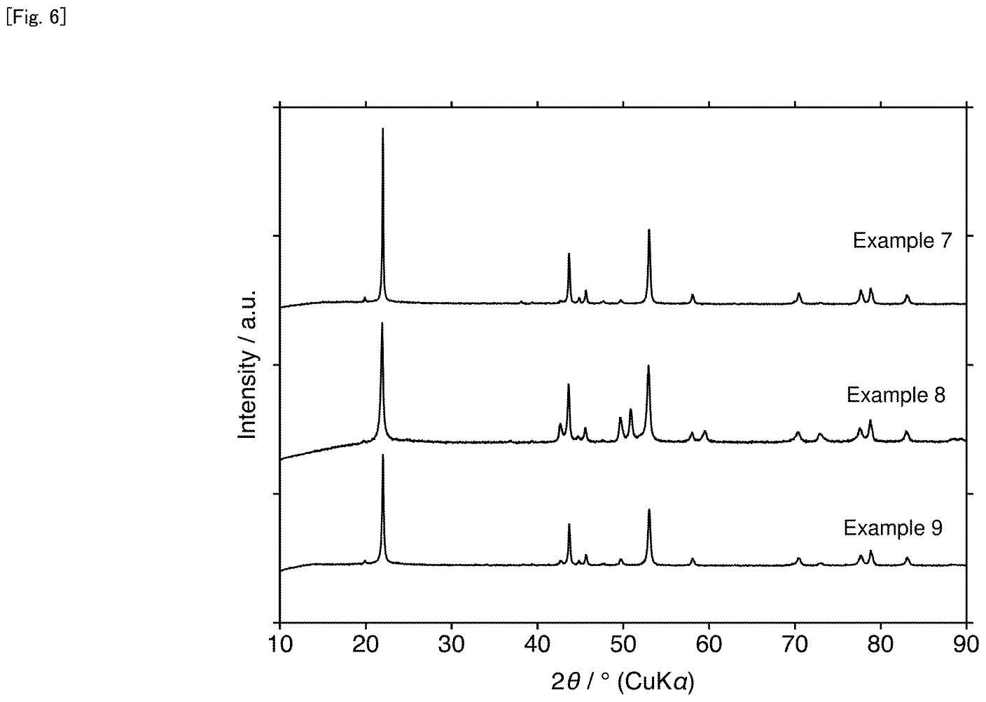

The LiCoO₂ powders produced in Examples 7 to 9 were analyzed by X-ray diffraction. The result is shown in FIG. 6.

It was found by the result shown by FIG. 6 that crystalline LiCoO₂ powder can be produced by further using potassium hydroxide in addition to lithium hydroxide monohydrate and sodium hydroxide in combination even at lower calcining temperature.

1-8. (canceled)

9. A method for producing a layered composite metal oxide crystal material,
wherein the layered composite metal oxide crystal material comprises a composite metal oxide represented by the following formula:
LiₓMO_{y}
wherein
M is 1 or 2 or more of transition metals, and a part of the M may be substituted with Al and/or Mg,
x is the number of 1 or more and 2 or less,
y is the number of 2 or more and 3 or less,
a value of x+n is 2×y, wherein n is an average valence of the transition metal M,
comprising the step of burning a mixture comprising lithium hydroxide, sodium hydroxide and/or potassium hydroxide, and a monovalent anion salt of the 1 or 2 or more of transition metal at 150° C. or higher and 400° C. or lower in the presence of a water molecule and oxygen,
wherein 0.2 times or more by mole of the sodium hydroxide and/or the potassium hydroxide is used to the lithium hydroxide, and
the transition metal comprises cobalt.

10. The method according to claim 9, wherein a hydrate is used as 1 or more of the salts selected from the group consisting of lithium hydroxide, sodium hydroxide and/or potassium hydroxide, and the monovalent anion salt of the transition metal.

11. The method according to claim 9, wherein the mixture comprises water.

12. The method according to claim 9, wherein a molar ratio of sodium hydroxide and/or potassium hydroxide to lithium hydroxide is 5 or less.

13. The method according to claim 9, wherein the mixture is burnt at an atmospheric pressure.

14. The method according to claim 9, wherein the mixture further comprises a monovalent anion salt of aluminum and/or magnesium in the case where a part of the M is substituted with Al and/or Mg.

15. A method for producing a positive electrode, comprising the steps of:
producing a layered composite metal oxide crystal material according to claim 9,
mixing the layered composite metal oxide crystal material with at least a solvent and a binder to produce a positive electrode slurry,
coating a positive electrode current collector with the positive electrode slurry, and
drying the positive electrode slurry on the positive electrode current collector.

16. A method for producing a lithium ion secondary battery, comprising the steps of:
producing a positive electrode on the positive electrode current collector according to claim 15,
producing a negative electrode on a negative electrode current collector,
producing a wound body by winding the positive electrode current collector having the positive electrode, the negative electrode current collector having the negative electrode, and a separator between the positive electrode current collector and the negative electrode current collector, and
placing the wound body in a battery container and injecting an electrolyte liquid into the battery container.

17. The method according to claim 10, wherein the mixture is burnt at an atmospheric pressure.

18. The method according to claim 11, wherein the mixture is burnt at an atmospheric pressure.

19. The method according to claim 12, wherein the mixture is burnt at an atmospheric pressure.
